(19) United States
(12) Patent Application Publication
(10) Pub. No.: US 2009/0152917 A1
(43) Pub. Date: Jun. 18, 2009

(54) APPARATUS, SYSTEM, AND METHOD FOR TUNEFUL ATTENUATION

(75) Inventors: Jeffrey Ostler, Salt Lake City, UT (US); Jamie Beers, Salt Lake City, UT (US)

Correspondence Address: Kunzler & McKenzie, 8 EAST BROADWAY, SUITE 600, SALT LAKE CITY, UT, 84111, US

(73) Assignee: i-Fi Company, LLC, Salt Lake City, UT (US)

(21) Appl. No.: 12/337,527

(22) Filed: Dec. 17, 2008

Related U.S. Application Data
(60) Provisional application No. 61/008,064, filed on Dec. 17, 2007.

(51) Int. Cl. A47C 7/72; H02K 41/035

(52) U.S. Cl. 297/217.4; 310/12.32

(57) ABSTRACT

An apparatus, system, and method for tuneful attenuation include at least one of speaker(s) and shaker(s) supported in a chair in a manner that enables at least one of resonance and even attenuation. In one embodiment, a shaker is mounted in a seat bottom by an attenuation member that includes a base and a plurality of somewhat flexible arms. The base is fixed to the shaker and the arms are coupled to a frame of the chair at positions that are at substantially equal distances from the shaker. Thus, the vibrations reach the frame at substantially the same time and are evenly and quickly attenuated. In other embodiments, the speakers and/or shakers are mounted in the chair by speaker cabinets that form part of and/or are rigidly fixed to the chair frame. In any case, vibrational energy transferred to the chair is better controlled and more tuneful.

### CROSS-REFERENCES TO RELATED APPLICATIONS

This application claims priority to U.S. Provisional Patent Application No. 61/008,064 entitled “APPARATUS, SYSTEM, AND METHOD FOR AN ENTERTAINMENT CHAIR”, filed on Dec. 17, 2007 for Jeffrey Ostler, which is incorporated herein by reference.

### FIELD OF THE INVENTION

This invention relates to generally to sound systems and more particularly relates to an entertainment chair that incorporates a high fidelity audio system.

### DESCRIPTION OF THE RELATED ART

Sound systems have been added to chairs in the past. Speakers have been placed in backrests or on wings near a headrest portion of the chair. Gaming chairs have been developed that include shakers in the seat bottoms that are activated at relatively low frequencies. Some massage chairs also have audio systems incorporated to add to the relaxation and overall experience of a seat occupant.

While many of these chairs include features that increase the sensory experience of the seat occupants, they fall short in providing apparatuses, systems, and methods that provide a high quality audio experience. Often their presentation of audio is disjointed and/or veiled relative to what a real or live audio experience would be.

### SUMMARY

Conventional audio systems are subject to overlapping of vibrations and frequencies, which causes undesirable sounds and resolutions of sounds referred to as “overhang” that limit the enjoyment that is available to users of these chairs.

From the foregoing discussion, it is apparent that a need exists for an apparatus, system, and method that at least enables and even creates a tuneful attenuation and tuneful resolution when playing music and other audio in an entertainment chair. Beneficially, such an apparatus, system, and method would provide a high fidelity audio chair that gives a maximum audio experience to a seated occupant of the chair. More particularly, such an apparatus, system, and method would provide transparency and imaging such that the seat occupant can repeatably and easily imagine the real or live audio when listening to recordings of a large variety of types and qualities.

The present invention has been developed in response to the present state of the art, and in particular, in response to the problems and needs in the art that have not yet been fully solved by currently available entertainment chairs. Accordingly, embodiments of the present invention have been developed to provide an apparatus, system, and method for tuneful attenuation of sounds and vibrations in entertainment chairs that overcome many or all of the above-discussed shortcomings in the art.

In a simple form, a chair shaker with an attenuator includes an electro-magnetic transducer configured to shake at least a first portion of the transducer relative to a second portion of the transducer when actuated by an electric impulse. The attenuator includes at least one attenuation member affixed to the first portion of the transducer. The attenuation member has a central section affixed to the first portion and a distal end that extends from the first portion. The distal end has an attachment mechanism for attachment to a frame of a chair.

In one embodiment, the attenuation member includes an attenuation plate. In one embodiment, the distal end is a first distal end and the attenuator has a second distal end extending from the first portion. The second distal end having a second attachment mechanism for attachment to a frame of a chair. The first and second attachment mechanisms are located at an equal distance from a center of the central portion.

In one embodiment, there are plural attenuation members each having a central section affixed to the first portion and a distal end that extends from the first portion. In this embodiment, the distal ends have attachment mechanisms for attachment to a frame of a chair. In one embodiment, the first and second attenuation members are transverse to each other. In one embodiment, the first and second attenuation members include respective plates that cross each other in the respective central sections and extend to opposite distal ends on each plate. The opposite distal ends of each plate have respective attachment mechanisms for attachment to a chair frame in this embodiment.

In another simple form, a chair shaker has an electro-magnetic transducer for converting an impulse into vibrations and an attenuation member with a base attached to the transducer. The attenuation member has a plurality of attachment mechanisms at locations that are equidistant from the base for attachment to a frame of a chair.

In one embodiment, the attenuation member include a plurality of arms extending from the base and the attachment mechanisms are on respective distal ends of the plurality of arms for attachment to a frame of a chair. There is an attachment location on the base. In this embodiment, the attachment mechanisms are each located at an equal distance from the attachment location. In one embodiment, the number of arms is two. In another embodiment, the number of arms is four.

In another simple form, a high fidelity audio chair includes structure that includes a frame and cushioning material. The chair has a shaker supported in the seat bottom. A vibration attenuation member is connected to the shaker for absorbing vibrations quickly and evenly after the shaker has produced the vibrations. The vibration attenuation member is coupled to the frame of the chair at a plurality of locations, each location substantially equidistant from the shaker.

In one embodiment, the vibration attenuation member includes a base fixed to the shaker and a plurality of arms each having an attachment mechanism at an equal distance from the base. In one embodiment, a plate of material forming the attenuation member has a dimension extending a major portion of at least one of a width and a depth of the seat bottom.

In another simple form, a system for tunefully coupling an audio system to a to chair includes the chair. The chair has a rigid frame. At least one of a speaker and a shaker are secured to the rigid frame by at least one of a speaker cabinet and an attenuation member. The at least one of the speaker cabinet and the attenuation member causes at least one of resonation and even attenuation of vibrations of all the speakers and shakers in the system. In one embodiment, the attenuation member is fixed to a shaker and coupled to the frame at a plurality of locations that are equidistant from the shaker. In another embodiment, the speaker cabinet is built into the chair and fixed to the frame.

In another simple form, embodiments of the invention include a method for creating tuneful vibrations in a high fidelity audio chair. The method includes utilizing a massive structure that includes at least a portion of at least one of a chair frame and cushioning material. The chair frame includes a plurality of rigid members fixed to each other. The method includes coupling at least one of a speaker and a shaker to the massive structure and attenuating vibrations from all of the speakers and shakers. In this regard, attenuating includes attenuating the vibrations evenly in at least one of the frame and an element coupling the speakers and shakers to the frame. In one embodiment, attenuating the vibrations evenly includes coupling a shaker to the frame by an attenuator element coupled to the shaker and coupled to the frame at a plurality of locations that are equidistant from the shaker. In another embodiment, attenuating the vibrations evenly includes providing a speaker cabinet fixedly attached to the chair frame and supporting a speaker in the speaker cabinet within the high fidelity audio chair.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. These drawings depict only typical embodiments of the invention and are not therefore to be considered to be limiting of its scope. Nevertheless the invention will be described and explained in greater detail through the use of the accompanying drawings, in which:

FIG. 1 is a perspective view of an embodiment of entertainment chair in accordance with the present invention;

FIG. 2A is a diagrammatic sectional view taken along line II-II of FIG. 1;

FIGS. 2B and 2C are diagrammatic sectional views taken along line IIB-IIB in FIG. 2A showing embodiments of a shaker and attenuator for the entertainment chair of FIGS. 1-2A;

FIG. 2D is a diagrammatic perspective view showing a shaker attached to a frame of a chair in accordance with another embodiment of the invention;

FIG. 3 is a diagrammatic partial sectional view taken along line III-III of FIG. 1;

FIG. 4 is a diagrammatic partial sectional view taken along line IV-IV of FIG. 1;

FIG. 5 is a rear plan view of the entertainment chair of FIGS. 1-2C and 3-4;

FIG. 6A is a detailed top plan view of a portion VI indicated in FIG. 1;

FIG. 6B is a diagrammatic sectional view taken along line VIB-VIB of

FIG. 6C-6D are diagrammatic perspective views showing variations on control panel configurations and control panel locations in accordance with alternative embodiments of the invention; and

FIG. 7 is a detailed perspective view of the portion VI indicated in FIG. 1, as viewed by a seat occupant.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described embodiments, features, structures, or characteristics of the invention may be combined in any manner and still remain within the spirit and scope of the embodiments of the present invention. In the following description, numerous specific details are provided, such as examples of user selections, structural variations, etc., to provide a thorough understanding of embodiments of the invention. However, it is to be understood that the invention may be practiced without one or more of the specific details, or with other methods, components, materials, and so forth. In other instances, well-known structures, materials, or operations are not shown or described in detail to avoid obscuring aspects of the invention.

The personal electronic devices referred to herein may include one or more of an iPod, an iPhone, a personal digital assistant (PDA), an MP3 player, and other personal electronic devices. The electronic connector may include one or more of an iPod sync, an iPhone sync, a PDA sync, a connector for an MP3 player, and connectors for other personal electronic devices. The entertainment chairs referred to in embodiments of the present invention are also high fidelity audio chairs such that the terms “entertainment chair” and “high fidelity audio chair” may be used interchangeably.

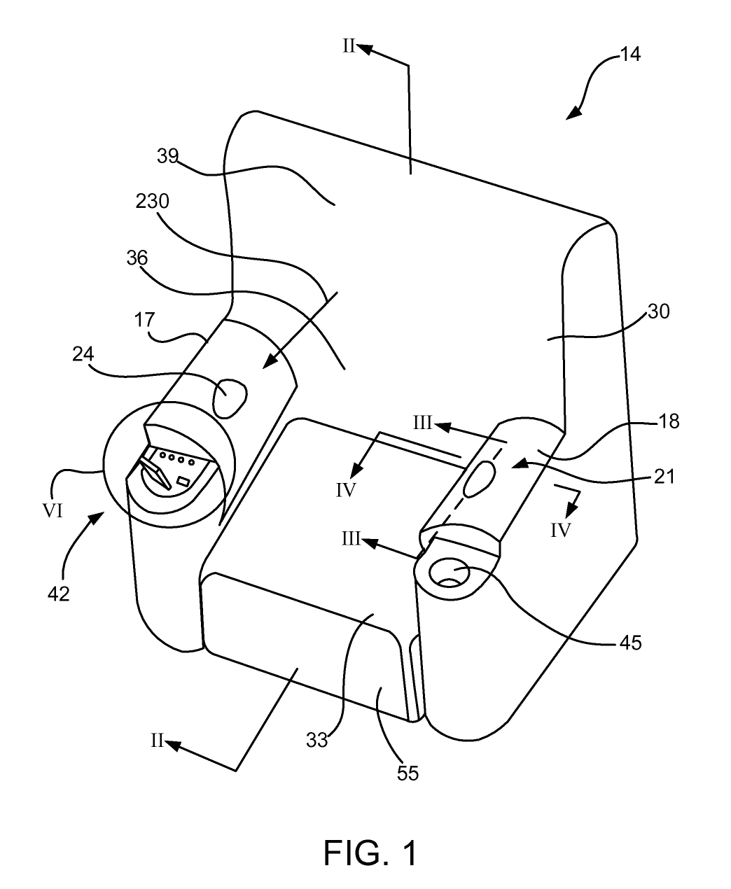

FIG. 1 is a perspective view of an embodiment of an entertainment chair 14 in accordance with the present invention. The entertainment chair 14 is a high fidelity audio chair that includes a pair of armrests or arms 17, 18, with a speaker unit 21 in each of the arms 17, 18. The speaker units 21 may have one or more speakers covered by a speaker cover 24 that may include a screen or other material with apertures to permit unrestricted flow of air between the speakers and an exterior of the speaker units 21. The speaker cover 24 generally defines a plane of the speaker faces of the speaker unit 21. In one embodiment, the speaker unit 21 is supported such that the faces of the speakers are directed diagonally upward and inward in a plane adjacent to and in front of a face of a seat occupant. In some embodiments, the faces of the speakers may be directed in inward or upward directions.

The speaker units 21 may alternatively be supported to direct sound in planes that are near a face or ears of a seat occupant. For example a facing direction may be on a line that extends below, above, to either side, or otherwise rearwardly past the face and/or ears of the seat occupant. This may be accomplished with a fixed or adjustable frame.

The entertainment chair 14 has a backrest 30 for supporting a back of a seat occupant and a seat bottom 33 for supporting the buttocks and legs of the seat occupant. The entertainment chair 14 may have a contoured surface including a lumbar support 36 and headrest 39 provided by a structure of the chair 14. The structure of the chair 14 may include a frame and cushioning material configured to provide an ergonomically comfortable chair. A control panel or platform 42 may be provided at a front end of one of the arms 17, and a drink holder 45 may be provided at the front end of the other of the arms 18. Alternatively, the control panel or platform may be positioned at any location on the chair, without limitation.

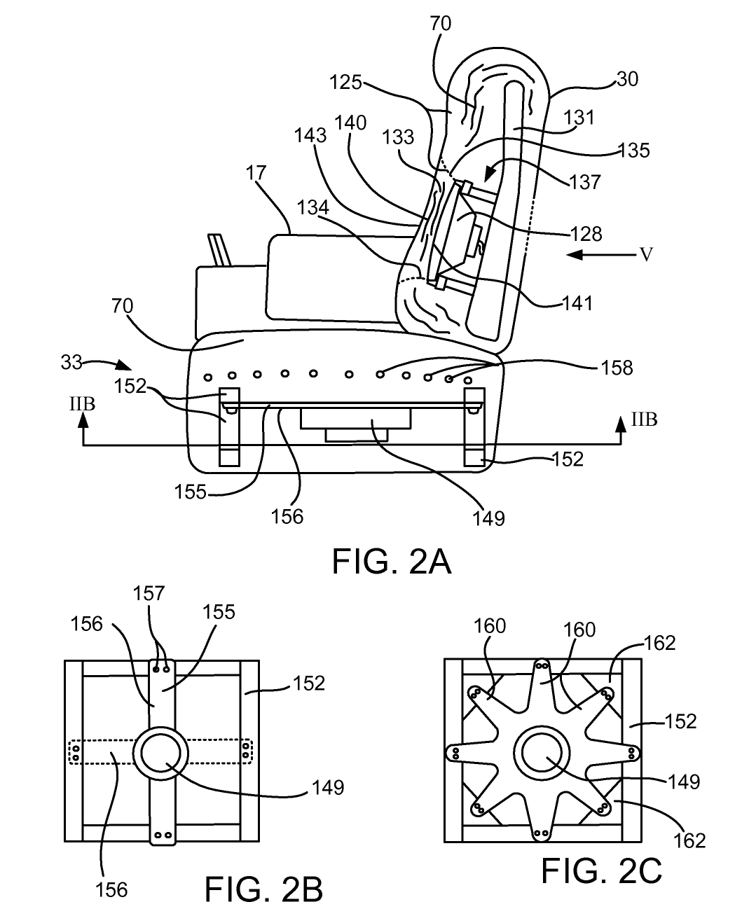

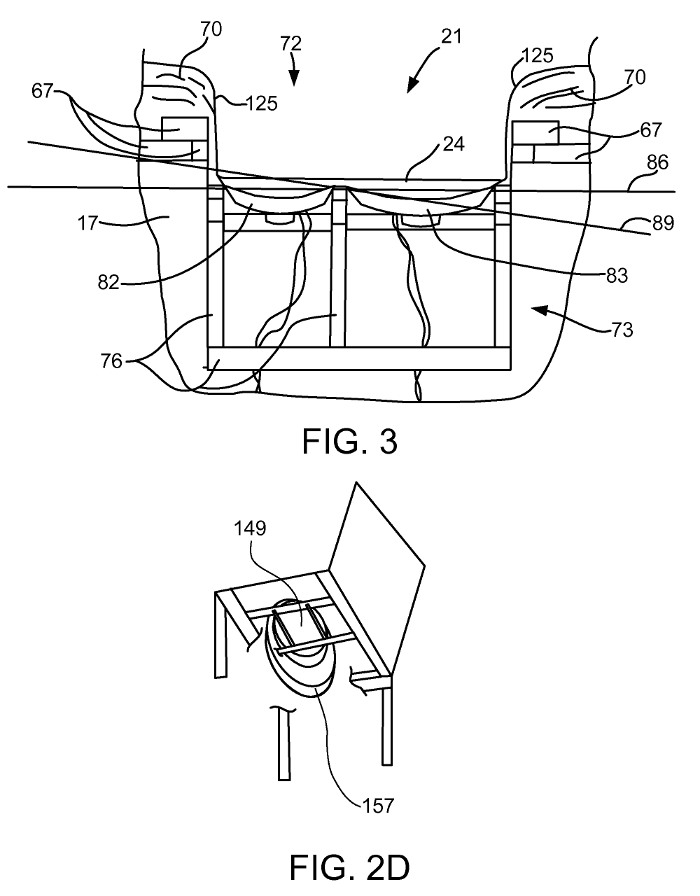

FIG. 2A is a diagrammatic sectional view taken along line II-II of FIG. 1 showing features inside the entertainment chair backrest 30 and seat bottom 33. The backrest 30 has a subwoofer speaker 128 (hereinafter “subwoofer”) disposed in the backrest 30. The chair 14 has a structure that includes a frame 131 and a cushioning material 70 in the backrest 30. In one embodiment, the structure forms a recess 133 in the backrest 30, and the subwoofer 128 is disposed in the recess 133. In FIG. 2A, the recess is shown between dashed lines 134, 135, indicating that the recess is an optional configuration. The structure supports the subwoofer 128 such that a face of the subwoofer 128 is directed toward at least one of a trunk and a lower back of a seat occupant. The frame 131 may include a speaker cabinet 137 with the subwoofer 128 supported in the speaker cabinet 137. The speaker cabinet 137 may be formed of a box or other structure.

In one embodiment, little or no material is disposed between a face of the subwoofer 128 and a body of the seat occupant. For example, there may be an air space in the recess 133 between the subwoofer face and a membrane 143 that spans the recess 133. The membrane 143 may simply be a portion of the upholstery 125 covering the chair 14, or may be formed of an additional sheet of material, which may be extremely flexible or flaccid. On the other hand, the membrane 143 may be only slightly flexible or even rigid. The membrane 143 may have through openings 146, as shown in FIG. 1. The through openings 146 enable air to flow freely between the face of the subwoofer 128 and the body of the seat occupant. Thus, aside from any clothing covering the seat occupant, the body of the seat occupant can thus be in fluid communication with the subwoofer 128. This, along with other features described herein, has the effect of helping to remove the veil that often exists in sound systems. Thus, the sound system of the embodiments of the present invention presents an unveiled or unmasked audio experience.

In other embodiments a material 140 may be disposed in the recess 133. However, the material disposed in the recess 133 may be a material that does not interfere or only interferes minimally with sound that is emitted from the speaker(s). The material 140 may be the same as the material 70 utilized to stuff other portions of the chair and may be separated from the active member of the subwoofer by a barrier 141 of speaker cloth, for example.

In an alternative embodiment, the subwoofer 128 or an analogous transducer is brought forward so that its face is substantially at the plane of a front surface of the backrest 30. The subwoofer 128 or other transducer, in this embodiment, is modified to include the membrane 143 as an active member of the subwoofer 128 or as an active member of another transducer utilized in place of the subwoofer 128. Thus, in this alternative embodiment, the subwoofer 128 or other transducer directly vibrates the membrane 143 that is in contact with the seat occupant.

FIG. 2A also shows a shaker 149 disposed in the seat bottom 33. The seat bottom 33 has a structure including a frame 152 and cushioning material 70. The shaker 149 is positioned in the seat bottom 33. With the placement of the subwoofer 128 in the backrest 30 and the shaker 149 in the seat bottom 33, the vibrations from the bass frequencies are felt and/or experienced by the body of the seat occupant while the tweeters and/or mid-range speakers 82, 83 are positioned for presenting the higher frequency sounds to the ears. In embodiments in which the chair 14 has one or more of tweeters and midrange speakers 82, 83 supported on the chair 14, the subwoofer 128 in the backrest 30, and the shaker 149 in the seat bottom, a 2.2 audio system is provided. Furthermore, the lower frequencies are directed to the trunk and upper legs of the seat occupant. Thus, frequencies that are felt as much or more than they are sensed by hearing are more realistically presented to the seat occupant. This and other features help to make the entertainment chair 14 a high fidelity audio chair that produces sound of extremely high quality with high levels of transparency and imaging. Furthermore, the shaker 149 and the subwoofer 128 are separately tunable and adjustable, as described below.

In alternative embodiments, tweeter and midrange speakers may be included at locations and/or may have orientations directing their sound to the trunk or other parts of a body of a seat occupant. Similarly, subwoofers and shakers may be placed to convey their vibrations to a head, face, ears, or limbs of a seat occupant, without limitation. The locations for speakers and speaker units illustrated in the drawing figures may have any transducer or speaker capable of transmitting vibrations in any range of frequencies. These speakers or transducers may alternatively be positioned in other locations relative to the chair and oriented in other directions than those shown.

Other features also aid in producing a high quality of audio and other sensory vibrations. For example, a vibration attenuation mass may be provided at least in part by an attenuation member or attenuator 155 that is connected to the shaker 149 for attenuating and/or transferring vibrations relatively quickly after the shaker 149 has produced the vibrations. The attenuation member 155 is also coupled to the frame 152 of the chair 14 such that the vibration attenuation mass also includes at least a portion of the chair frame 152 and/or other structure of the chair. The connection between the shaker 149 and the attenuation member 155 is direct and rigid so that a large percentage of the vibrations produced by the shaker 149 propagate into the attenuator 155.

In one embodiment, the vibration attenuation member 155 includes a plate 156 of at least partially flexible material coupled to the shaker 149. The plate may be formed of metal and may function as a relatively stiff spring that flexes at least slightly yet absorbs vibrations quickly. As shown in the sectional view of FIG. 2B, the plate 156 may be one of a plurality of plates 156 that cross each other. The additional plate 156 is shown in dashed lines to indicate that it is optional. One plate 156 functions to provide flexing yet quick attenuation. A plurality of plates 156 can multiply the beneficial effect of flexing and quick attenuation by attaching to a plurality of locations on the frame. The plurality of plates 156 may be fixed at a central base region to the shaker 149. Attachment mechanisms 159 such as bolts or other fasteners may couple distal ends of the plates 156 to the frame 152 at positions that are each an equal distance from an attachment of the plates 156 to the shaker 149. Each half of the plates 156 forms an arm of equal length that attaches the shaker 149 to the frame 152.

In one embodiment, the vibration attenuation member 155 includes the plate(s) 156 of material that may have a size extending a major portion of a width of the seat bottom. This has the effect of increasing the size of the transducer or shaker 149, and spreads the shaking from the transducer or shaker 149 over a broader area of the seat bottom 33 and the chair 14 overall. The plate(s) 156 may be elongate, as shown in FIG. 2B, or may be round, square, or of any configuration. The cushioning material 70 may include springs 158 (shown in FIG. 2A) in the seat bottom. In one embodiment, the plate(s) 156 of material are coupled to the springs 158 by any of a variety of fasteners. In one embodiment, the plate of material is coupled to the springs 158 by an interleaved configuration in which the plate of material extends between respective springs 158 or portions of one or more springs 158.

FIG. 2C is a diagrammatic sectional view similar to FIG. 2B and showing the attenuator 155 in accordance with an alternative embodiment. In the embodiment of FIG. 2C, the attenuator is formed of one integral piece of material having a central base fixed to the shaker 149 and a plurality of arms 160 attached by attachment mechanisms 159 to the frame 152. As may be appreciated, corner gussets 162 may be included in the frame 152 such that the attachment mechanisms 159 may be located at equal distances from the shaker 149 on all of the arms 160. Attaching the attenuation member at a plurality of locations that are each equal distance from an attachment location of the shaker to the attenuator 155 enables the vibrations to arrive at the rigid seat frame 152 at substantially the same instant in time for a tighter, more accurate representation of the vibrations being generated. This can be explained based on the principle of propagation of waves or vibrations. By way of example, when a pebble is thrown in a pond, the ripples propagate outward at the same rate in every direction. Similarly, the vibrations from the shaker propagate outward in plural directions at the same rate. By making the distances between the attachment location of the shaker and the attachment locations of the attachment mechanisms equal, the vibrations arrive at the chair frame 152 at the same instant or substantially the same instant in time.

The attenuation member 155 may have greater or lesser numbers of arms 160 and may be formed of any of a variety of materials including one or more of metals, plastics, composites, etc. In some embodiments, the attenuator 155 may be formed of metal and have a relatively large mass compared with a mass of the shaker 149. In one embodiment, the vibration attenuation member 155 may be formed predominately of a homogeneous material and/or may include tightly coupled elements as opposed to being formed of a combination of loosely connected members that may have a large variety of resonance and/or damping characteristics. In some embodiments, the vibration attenuation member 155 does not have arms. Nevertheless, the distances between the attachment location of the shaker 149 and the various attachment mechanisms may be equal. The vibration attenuation member 155 and its connections may be configured to more accurately simulate a natural presentation of vibrations that would be felt by the occupant through an environment and objects in that environment in a real or live setting. As such, the vibration attenuation member 155 does not overly dampen the vibrations. Rather, it provides a natural attenuation and avoids overhang. Thus, the vibration attenuation member 155 can provide a tighter transmission of the lower frequency vibrations, which transmission remains more true to the signal from which the vibrations are derived. A similar attenuation member could be used to connect the subwoofer and/or other speakers in the seat back 58 and other portions of the chair 14.

In an alternative embodiment for the shaker, FIG. 2D shows that the vibration attenuation mass may include frame members or other members of the chair itself to which the shaker 149 is attached. In a further alternative embodiment, the shaker 149 may be attached to a vibration attenuation mass 157 that is also shown in FIG. 5. The vibration attenuation mass 157 may be of any shape and size and may be unattached relative to other structure of the chair. Thus, in one embodiment, the attenuation mass 157 is only attached to the chair via the shaker 149 such that the mass 157 is free to move unencumbered except by the forces of the shaker 149 when it vibrates and gravity. Further alternatives include attaching the attenuation mass 157 to other members of the chair or to materials with particular attenuation properties. Still further, the shaker itself may be attached to materials that have particular attenuation properties. The materials may include but are not limited to one or more of liquids such as water, gels, rubbers, plastics, and metals.

The backrest 30 of the chair 14 may be of the reclining type. Also, a front portion 55 of the seat bottom 33 may form a retractable foot rest and/or leg rest. The chair 14 may be of the overstuffed or cushioned armchair type that incorporates one or more of a variety of springs, foam, stuffing and/or other cushioning materials. Alternatively, the chair may be any of a variety of chairs including but not limited to a folding chair, an office chair, a massage chair, a gaming chair, and a motor vehicle seat.

With an overview of basic components of the entertainment chair 14 set forth above, we now turn to several details of embodiments of the invention in which FIG. 3 is a diagrammatic partial sectional view taken along line III-III of FIG. 1. Structure in the arm 18 includes frame members 67 and cushioning material 70. The structure may help to form a recess 72 in the armrest. Alternatively, the speaker units 21 may be generally mounted flush with the outer surface of the arms 17, 18 of the chair 14. A speaker cabinet 73 in each of the pair of chair arms 17, 18 supports the speaker units 21 in the recess 72 or in a flush mounted position, as the case may be. The speaker cabinet 73 may be formed by cabinet frame members 76 similar to the frame members 67 that form the arms 17, 18 and other portions of the chair 14. Alternatively, other structure such as a box may provide the speaker cabinet 73.

As shown in FIG. 3, the speaker cover 24 is generally co-planar with or parallel to faces of at least one of a tweeter speaker 82 and a midrange speaker 83. Alternatively, the speaker cover 24 and/or the speaker unit 21 may be mounted substantially flush with an outer surface of the arms 17, 18. One or more of the tweeter and midrange speakers 82, 83 make up the speaker unit 21 that is supported in the speaker cabinet 73. In one embodiment, the speaker cabinet 73 is configured to support the speakers 82, 83 such that they face upwardly, inwardly, and in a direction that is perpendicular to a horizontal plane represented by axis 86. In another embodiment, the speaker cabinet 73 is configured to support the speakers 82, 83 with their faces directed upwardly, inwardly, and rearwardly generally toward the face or ears of a seat occupant. This direction is perpendicular to a plane represented by axis 89, and may be adjustable in some embodiments.

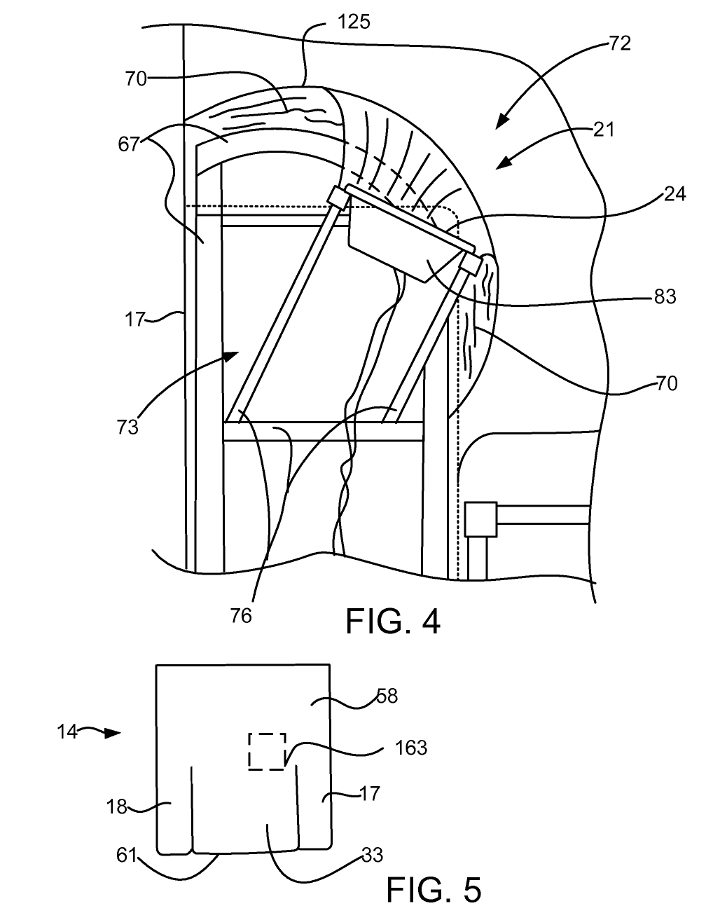

FIG. 4 is a diagrammatic partial sectional view taken along line IV-IV of FIG. 1. This view further elucidates structure and details discussed with regard to FIG. 3. The plane of section IV-IV is perpendicular to the plane of the section of FIG. 3. FIG. 4 shows the cushioning material 70 and the frame members 67 forming the armrest or arm 17. FIG. 4 further illustrates structure in the arm 17 that forms the recess 72. The recess 72 is formed in part by the cushioning material 70. The recess 72 is also formed, at least in part by the speaker cabinet 73. The speaker cabinet 73 may be formed in part by frame members 67, and by the cabinet frame members 76. As may be appreciated, the cabinet 73 may be formed to present the speaker units 21 and speaker cover 24 in a generally flush mounted position relative to an outer surface of the chair arms 17, 18. The inward and upward angle of the speaker cabinet 73, and the resultant supported orientation of the face of the speaker 83 in an inward and upward direction is clearly shown in FIG. 4. One or more speakers 82, 83, or the pairs of speaker units 21 may be placed in respective arms 17, 18. The speakers 82, 83 may be balanced in positions and orientations relative to a position of a face of a seat occupant.

Little or no material is disposed between a face of the speaker 82, 83 and a face of a seat occupant. For example, as shown in FIGS. 3 and 4, a seat covering or upholstery 125 may end at an edge of the speaker units 21 and/or at an edge of the recess 72 so that a single opening is formed around the speaker unit 21. The cover 24 permits free passage of air therethrough, as discussed above. In an alternative embodiment, the upholstery 125 may extend over the recess 72, and there may be an air space between the speaker face and a portion of the upholstery 125 covering the recess 72. The portion of the upholstery 125 may have through openings that enable air to flow freely between the speaker face and the face of the seat occupant in a configuration similar to the embodiments of the recess 133 and speaker 128 shown and described with regard to the backrest 30 in FIGS. 1 and 2A. In one embodiment, the recess 72 may have a material therein. In one embodiment, a material that causes minimal interference with the vibrations being emitted from the speaker(s) is disposed in the recess 72.

FIG. 5 is a rear plan view of the entertainment chair 14 of FIG. 1 in accordance with an embodiment of the invention. The backrest 30 is part of a seat back 58 that is viewed from a rear of the chair 14. The seat back 58 is connected to the arms 17, 18 that are shown extending to a ground level. Alternatively, the seat back 58 may be connected directly to the seat bottom 33. The arms 17, 18 straddle the seat bottom 33. The seat bottom 33 may have a panel of material or door 61 that can be opened to access components inside the chair 14. For example, the components may include at least one of a transformer, speaker(s) and shaker(s) to be described in greater detail below. The speakers and other components may alternatively be accessible through other surfaces of the chair.

FIG. 5 also has a porthole 163 of speaker cloth or other material that does not inhibit or only minimally inhibits transmission of air and sound waves through the cover of the chair 14. The porthole 163 may have a color and/or texture that is similar to the rest of the cover material or upholstery on the chair so that it is not visible or only minimally visible to an observer. On the other hand, the porthole 163 has the effect of enabling air to move out of the seat back 58 from aback side of the subwoofer 128. In this way, the seat back 58 may be completely enclosed and still allow air to move back and forth through the porthole 163. This configuration enables lower bass sounds with less power.

It is to be understood that a chair in accordance with the embodiments of the present invention may take any form including, but not limited to folding chairs, arm chairs, gaming chairs, massage chairs, motor vehicle seats, and office chairs. The examples of specific types of speakers or other transducers and their positions, as described with regard to FIGS. 1-5, are to be non-limiting. That is, the transducers may be of any type whether shakers or speakers, and whether capable of emitting high or low frequency vibrations. The term speaker may be replaced by the term shaker, and the term shaker may be replaced by the term speaker. Other configurations not show in the figures are considered within the scope of the invention. For example, adding more speakers or speakers in different positions in the chair is within the spirit and scope of the present invention.

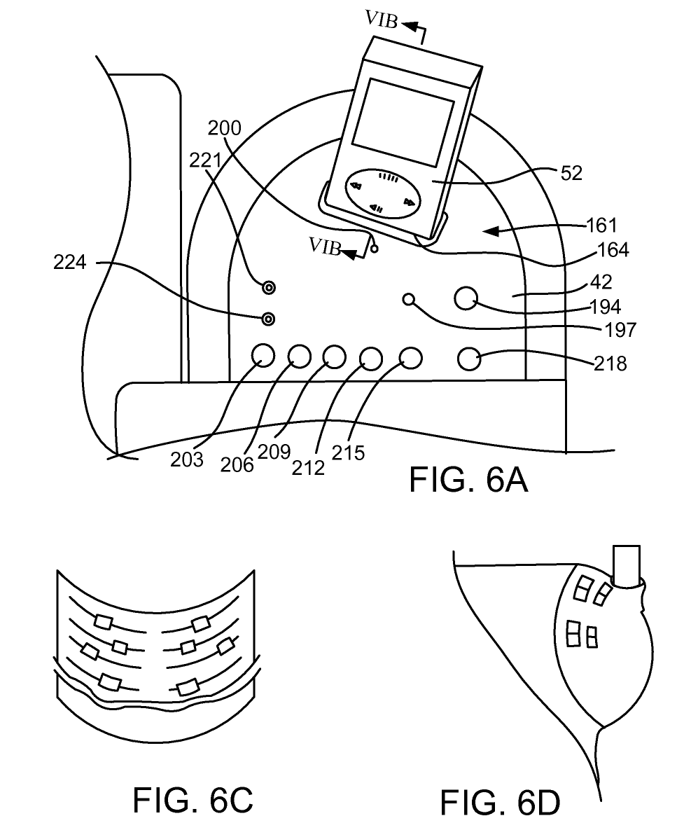

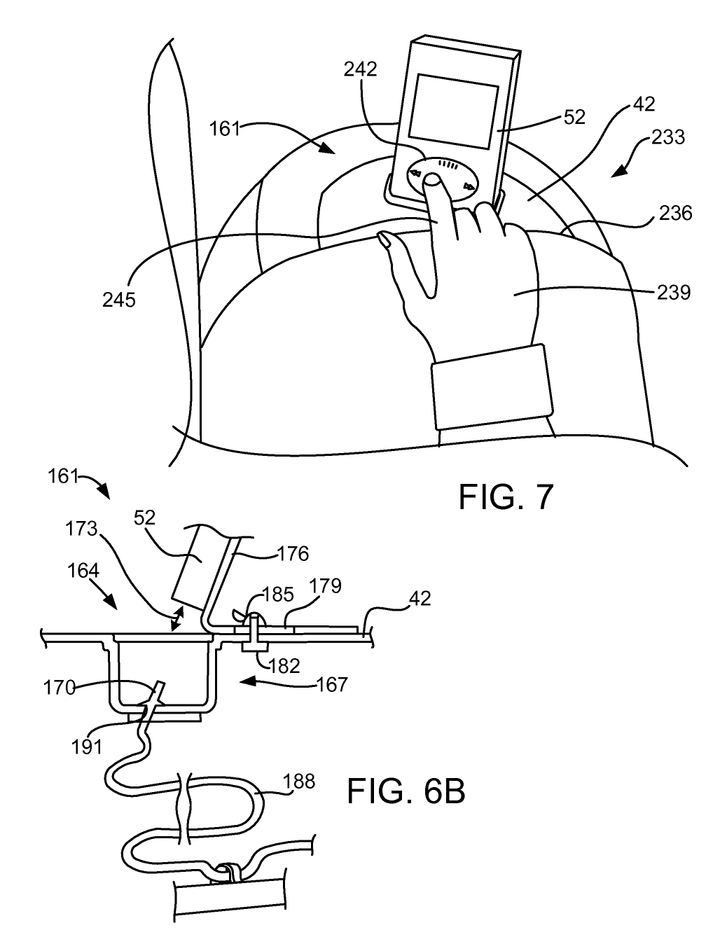

FIG. 6A is a detailed top plan view of a portion VI indicated in FIG. 1, and shows the control panel or platform 42 with greater specificity. The control panel 42 includes a docking station 161 for a personal electronic device 52, which, in the example illustration, is shown as an iPod. The docking station 161 may have a platform 42 with a relatively flat configuration, and the platform 42 may have a sync 167 for an iPod or other personal electronic device 52 supported on the platform 42. In one embodiment, however, the platform 42 has a recess 164, and the sync 167 is disposed in the recess 164, as illustrated in the sectional view of FIG. 6B taken along line VIB-VIB of FIG. 6A.

As shown in FIG. 6B, the sync 167 includes an electronics connector 170 that receives an iPod or other personal electronic device 52 for charging and transmission of signals to and/or from the audio system of embodiments of the present invention. The electronics connector 170 may be a multi-pin or other connector that is capable of being coupled to existing or future ports in personal electronic devices 52. As indicated by the double-headed arrow 173, the personal electronic device 52 is removable, and can be docked and removed from the docking station 161.

In an embodiment of the invention, the docking station 161 is a universal docking station for personal electronic devices 52 of a variety of styles, shapes, and sizes. Therefore, the docking station 161 may include an adjustable support 176 that is slidably coupled to the platform 42. As shown, the slidable connection may include a slot 179 in the adjustable support 176, a part of a fastener such as a bolt 182 fixed to the platform 42, and another part of the fastener such as a wing nut 185 received on the bolt 182. Thus, the adjustable support 176 can be slid fore and aft to accommodate any of a variety of personal electronic devices 52 connected to the sync 167, which variety of personal electronic devices may have a variety of thicknesses and other sizing requirements that necessitate adjustment of the adjustable support to securely protect the connection. The wing nut 185 can be tightened on the bolt 182 to cause a clamping action on a base of the adjustable support 176 to hold the adjustable support 176 in a position that matches the size and shape of a particular personal electronic device 52. One or more of the recess 164, the personal electronic device electronics connector 170, and the adjustable support 176 forms a generally cantilever support that orients and holds a personal electronic device 52 in a generally upright position. The upright position includes extending upwardly and forwardly from the platform 42, as shown in FIGS. 6A and 6B.

Other structures may be incorporated in addition to or in place of those described here for supporting one or more of a variety of personal electronic devices 52. For example, one or more removable plugs or filler sockets having recesses 164 for devices 52 of specific sizes could be provided. Alternatively, a retractable and/or adjustable support could be stored in the platform and deployed when supporting a personal electronic device 52. Also, although the personal electronic device 52 is shown as being supported in a lengthwise upright orientation, the recess 164 could be configured to accommodate devices 52 in lengthwise reclined or other orientations without limitation.

As shown in FIG. 6B, in one embodiment, the electronics connector 170 of the sync 167 may be detachably supported on the platform 42. The electronics connector 170 may be withdrawn from a stowed condition shown in FIG. 6B to a deployed condition by pulling a stem of the connector 170 from an opening 191 in the platform 42, and thereby releasing the connector 170 from a friction fit or other releasable connection to the platform 42. In this embodiment, a retractable line 188 forms a flexible tether with the electronics connector 170 at its distal end. The retractable line 188 can be moved out from an interior of the arm 17 through an opening 191. Thus, if a personal electronic device 52 does not fit in the recess 164, or if a user wants to connect a device remotely, the line 188 can be extended to a location and orientation other than a specific position on the platform 42.

Referring back to FIG. 6A, the platform 42 has a power button 194 for turning an audio system associated with the chair 14 on and off. The platform also has a channel selection button 197 for selecting a different channel in the case where the transmitter on a home entertainment system has interference from other signals, for example. An indicator light 200 indicates when a personal electronic device 52 has been connected to the electronics connector and is charging. Other controls are disposed on the platform 42, including a subwoofer volume control knob 203, a subwoofer frequency control knob 206, a shaker volume or amplitude control knob 209, a shaker frequency control knob 212, and a satellite volume control knob 215. These controls enable separate or independent control of each of the subwoofer 128, shaker 149, and mid-range/tweeter speakers 82, 83. The subwoofer 128 is controlled by knobs 203, 206. The shaker 149 is controlled by knobs 209, 212, and the mid-range and/or tweeter speakers 82, 83 are controlled by knob 215. The frequency control knobs 206 and 212 control a maximum frequency that will be transmitted to the subwoofer 128 and the shaker 149, respectively. In this way, a seat occupant can select a level of frequencies below which each of the subwoofer 128 and shaker 149 will transmit vibrations based on the signal being received by the audio system. The seat occupant can also independently select the volume or amplitude of the vibrations to be delivered by the subwoofer 128 and the shaker 149 by adjusting the knobs 203 and 209, respectively. The seat occupant adjusts the volume of the mid-range and/or tweeter speakers 82, 83 through adjustment of the knob 215, and the frequencies for these speakers 82, 83 may be limited only by the capacity of the speakers 82, 83 themselves. Additional or alternative controls are possible, as is suggested by the following description.

FIG. 6C-6D are diagrammatic perspective views showing variations of control panel configurations and control panel locations in accordance with alternative embodiments of the present invention. In the alternative embodiments, the control knobs may be replaced by sliding buttons as shown in FIG. 6C, or rocker switches as shown in FIG. 6D. It is to be understood that the control panel or platform need not be relatively flat, as shown in FIGS. 1-2A, and 6A-6B. Also, the control panel or platform need not be positioned forward and below an armrest portion of a chair. Rather, the platform may be rounded in any of a variety of configurations, non-limiting examples of which are shown in FIGS. 6C and 6D. Locations for the panel may include an inner surface or outer surface of an arm. The controls may be split among a plurality of control panels, and the one or more control panels may be additionally or alternatively located on top of an arm or under a front edge of seat bottom. In another alternative, the control panel may be adjustably supported on an adjustable support. Thus, the control panel may be stowed and deployed as desired, and is adjustable to any desired position of use. Further alternatively, the controls may be disposed on a control panel or platform supported on a post that is to be straddled by the legs of the seat occupant such as in a game chair. The configurations shown and described herein are examples only, and the controls or control panels or platforms may be provided at any other location on or near a chair, and may be applied with any of a variety of chair styles and configurations. Any of these panels may include a personal electronic device sync, which may include one or more features of the syncs and docking stations described with regard to other embodiments herein. Further alternatively, a remote control wand could include control buttons, knobs, and/or switches for wireless connection to the personal electronic devices, audio system, and/or auxiliary devices associated with the audio systems in accordance with embodiments of the invention. Still further alternatively, a wired or tethered remote control wand may be utilized.

While FIG. 6A shows a volume control knob and frequency control knob for each of the subwoofer and shaker, it is to be understood that similar pairs of knobs may be provided for any number of speakers whether they be woofers, subwoofers, shakers, tweeters, or midrange speakers. Also, a combination of a fade adjustment between two or more speakers may replace the function of the volume control. In this way, a fader and frequency control for any speaker can be used to adjust both amplitude and a maximum frequency in accordance with an embodiment of the present invention. In one embodiment, frequency adjustment mechanisms with which a user may select a specific range of frequencies can be implemented. Touch screen controls, clickable soft buttons, stylus engagable controls, and any other user interface mechanisms for adjusting at least one of an amplitude and a frequency or range of frequencies are within the spirit and scope of the present invention.

FIG. 6A also shows a mode selection knob 218 that enables the seat occupant to adjust a mode of operation of the sound system between personal electronic device mode, wireless mode, and auxiliary mode, for example. Other modes are also available, and all or part of this feature may be applied to a control panel or platform of any configuration. When a seat occupant wishes to wirelessly connect to a radio, television, or other home entertainment device he or she can switch the knob 218 to the wireless mode in which a receiver in the audio system of the chair 14 receives the signals and produces sounds corresponding to the signals. When a seat occupant wishes to play music or other recordings from an MP3 player, DVD player, or other device through a wired connection, the device can be connected through an auxiliary input 221 and the knob 218 can be switched to the auxiliary mode. In the auxiliary mode, the auxiliary device is connected to and transmits its signals to the audio system of the chair 14 for high quality audio production. When a seat occupant wishes to utilize an iPod or other personal electronic device 52, he or she can dock the device 52 in the docking station 161 and turn the knob 218 to the personal electronic device mode for transmission of signals from the device 52 to the audio system of the chair 14. In any of these modes a user may choose to utilize headphones that can be plugged into the headphone jack 224.

FIG. 7 is a detailed perspective view of a portion VI indicated in FIG. 1, as viewed by a seat occupant in a direction of arrow 230 in FIG. 1. The personal electronic device docking station 161 with platform 42 and sync 167 (FIGS. 6A-6B and 7) may thus be applied to a comfortable armchair or overstuffed chair or sofa. The chair 14 is a high fidelity audio chair that also has structure including a frame and cushioning material that form ergonomic armrests and hand rests 233. The ergonomic hand rest 233 includes a contour provided at least in part by the frame members and cushioning material that form a rounded forward edge 236 of an armrest portion of the arms 17 and 18, as shown in FIGS. 1 and 7. The ergonomic hand rest 233 may also include at least a portion of the platform 42 with its docking station 161 and controls. The platform 42 is adjacent to an upholstered portion of one of the armrests or hand rests 233 of the chair 14. A cushioning material 70 may include a stuffing material in the upholstered portion. The upholstered portion forms the rounded portion of the ergonomic hand rest 233 that extends downward and forward to the platform 42.

The relationship of the platform 42 and the front edge 236 of the armrest portion of the arm 17 allows a hand 239 of a seat occupant to lie comfortably with the fingers extending over the edge 236 toward the platform 42. In this position, the wrist and hand extends generally straight forward in alignment with the forearm of the seat occupant so that there is no strain on the wrist or forearm. In this position, the seat occupant has ready and easy access to the controls and sync 167. The ergonomic configuration enables fingertip manipulation of the knobs 203, 206, 209, 212, 215, 218, the personal electronic device 52, and associated components. (See FIGS. 6A and 7). For example, the seat occupant can easily control recorded media on his/her iPod or other device 52 by engaging controls 242 on the device 52 with his or her finger 245. The adjustable support 176 supports the personal electronic device 52 at an angle that allows the seat occupant to view the screen 248 without strain to the eyes or neck. The support 176 also protects against inadvertent damage to the electronics connector 170 of the docking station 161, as described above, and allows the seat occupant to engage the controls 242 of the device 52 without fear of damaging the electronics connector 170.

While FIGS. 6A-6B and 7 show how a personal electronic device 52 extends in a generally upright cantilevered position from the platform 42 that is positioned forward of the cushioned portion of arm 17, it is to be understood that the personal electronic device 52 may be supported at any other location and in any other orientation without limitation.

In alternative embodiments, the hand rest and/or armrest are not necessarily ergonomic. For example, the controls may be placed in a position that is not necessarily comfortable or convenient, and one or more other features of the embodiments of the present invention may be incorporated into a chair. Similarly, the Chair itself may not be a particularly comfortable chair. For example, the chair may be a folding chair, and the sound system in accordance with embodiments of the present invention may be incorporated into a folding chair. Further alternatively, the chair may be a gaming chair and may have a configuration and structure similar to other gaming chairs. The chair may or may not include arms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A chair shaker with an attenuator, comprising:
an electro-magnetic transducer configured to shake at least a first portion of the transducer relative to a second portion of the transducer when actuated by an electric impulse; and
an attenuator comprising at least one attenuation member affixed to the first portion of the transducer;
wherein the attenuation member has a central section affixed to the first portion and a distal end that extends from the first portion, the distal end having an attachment mechanism for attachment to a frame of a chair.

2. The shaker and attenuator of claim 1, wherein:
the distal end is a first distal end; and
the attenuator has a second distal end extending from the first portion, the second distal end having a second attachment mechanism for attachment to a frame of a chair.

3. The shaker and attenuator of claim 2, wherein the first and second attachment mechanisms are located at an equal distance from a center of the central portion.

4. The shaker and attenuator of claim 1, wherein the attenuation member comprises an attenuation plate.

5. The shaker and attenuator of claim 1, wherein the attenuation member is a first attenuation member, the attenuator further comprising a second attenuation member having a central section affixed to the first portion and a distal end that extends from the first portion, the distal end having an attachment mechanism for attachment to a frame of a chair.

6. The shaker and attenuator of claim 5, wherein the first and second attenuation members are transverse to each other.

7. The shaker and attenuator of claim 5, wherein the first and second attenuation members comprise respective plates that cross each other in the respective central sections and extend to opposite distal ends on each plate, the opposite distal ends each plate having respective attachment mechanisms for attachment to a chair frame.

8. A chair shaker, comprising:
an electro-magnetic transducer for converting an impulse into vibrations;
an attenuation member having a base attached to the transducer;
the attenuation member having a plurality of attachment mechanisms at locations that are equidistant from the base for attachment to a frame of a chair.

9. The chair shaker of claim 8, wherein the attenuation member comprises:
a plurality of arms extending from the base; and
the attachment mechanisms on respective distal ends of the plurality of arms for attachment to a frame of a chair.

10. The chair shaker of claim 9, further comprising an attachment location on the base, wherein the attachment mechanisms are each located at an equal distance from the attachment location.

11. The chair shaker of claim 9, wherein the number of arms is two.

12. The chair shaker of claim 9, wherein the number of arms is four.

13. A high fidelity audio chair, comprising:
structure that includes a frame and cushioning material;
a seat bottom with a shaker supported in the seat bottom;
a vibration attenuation member connected to the shaker for absorbing vibrations quickly and evenly after the shaker has produced the vibrations; and
the vibration attenuation member coupled to the frame of the chair at a plurality of locations, each location substantially equidistant from the shaker.

14. The high fidelity audio chair of claim 13, wherein the vibration attenuation member includes at least one plate of material.

15. The high fidelity audio chair of claim 14, wherein:
the vibration attenuation member comprises a base fixed to the shaker and a plurality of arms each having an attachment mechanism at an equal distance from the base; and
the attachment mechanisms are coupled to the frame of the chair.

16. The high fidelity audio chair of claim 14, wherein the plate of material has a dimension extending a major portion of at least one of a width and a depth of the seat bottom.

17. A system for tunefully coupling an audio system to a to chair, the system comprising:
a chair having a rigid frame; and
at least one of a speaker and a shaker secured to the rigid frame by at least one of a speaker cabinet and an attenuation member;
wherein the at least one of the speaker cabinet and the attenuation member causes at least one of resonation and even attenuation of vibrations of all the speakers and shakers in the system.

18. The system of claim 17, wherein the attenuation member is fixed to a shaker and coupled to the frame at a plurality of locations that are equidistant from the shaker.

19. The system of claim 17, wherein the speaker cabinet is built into the chair and fixed to the frame.

20. A method for creating tuneful vibrations in a high fidelity audio chair, the method comprising:
providing a massive structure including at least a portion of a chair frame and cushioning material, wherein the chair frame comprises a plurality of rigid members fixed to each other;
coupling at least one of a speaker and a shaker to the massive structure;
attenuating vibrations from all of the speakers and shakers, wherein attenuating comprises attenuating the vibrations evenly in at least one of the frame and an element coupling the speakers and shakers to the frame.

21. The method of claim 20, wherein attenuating the vibrations evenly comprises coupling a shaker to the frame by an attenuator member coupled to the shaker and coupled to the frame at a plurality of locations that are equidistant from the shaker.

22. The method of claim 20, wherein attenuating the vibrations evenly comprises providing a speaker cabinet fixedly attached to the chair frame and supporting a speaker in the speaker cabinet within the high fidelity audio chair.
